(19) United States
(12) Patent Application Publication
(10) Pub. No.: US 2009/0234913 A1
(43) Pub. Date: Sep. 17, 2009

(54) DATA STRUCTURE FOR INITIATING MULTIPLE WEB SITES

(76) Inventor: John Lee, Miami Beach, FL (US)

Correspondence Address: CAREY, RODRIGUEZ, GREENBERG & PAUL LLP;ATTN: STEVEN M. GREENBERG, ESQ., 950 PENINSULA CORPORATE CIRCLE, SUITE 3020, BOCA RATON, FL, 33487, US

(21) Appl. No.: 12/191,936

(22) Filed: Aug. 14, 2008

Related U.S. Application Data
(63) Continuation-in-part of application No. 12/047,908, filed on Mar. 13, 2008.

(51) Int. Cl. G06F 15/16

(52) U.S. Cl. 709/203

(57) ABSTRACT

A method for facilitating the simultaneous initiation of a plurality of web sites can be provided. The method can include receiving from a client a request for a web page and sending to the client a first program logic configured for providing an interface. The method can further include receiving a plurality of URLs from the first program logic executing on the client. The method can further include generating a data construct, wherein the data construct includes a second program logic configured for sending a separate request to each of the plurality of URLs and further configured for receiving web site data from each of the plurality of URLs and displaying the web site data in the interface. The method can further include generating a first URL that references the data construct and sending the first URL to the client.

### CROSS-REFERENCE TO RELATED APPLICATIONS

The present patent application is a continuation in part of U.S. utility patent application Ser. No. 12/047,908 filed on Mar. 13, 2008 and entitled “SIMULTANEOUS SEARCHING USING MULTIPLE SEARCH ENGINES.” The present patent application claims priority to U.S. utility patent application Ser. No. 12/047,908, which is hereby incorporated by reference in its entirety.

### BACKGROUND OF THE INVENTION

1. Field of the Invention

The present invention relates to the field of software and more particularly to software that facilitates network searching and network navigation.

2. Description of the Related Art

Computer-based search engines are well known in the art. Typically a search engine comprises a software application that is executed on a data processing system and includes a user interface and a database of information that is stored on a memory component associated to or accessible by the data processing system. The information (data, documents, articles, etc.) within the database is made accessible to a user via the user interface of the data processing system. The user enters a search query in the user interface and submits the query to the search engine/application for processing. The search engine parses the query into search keys and uses those keys to access a set of keywords associated with various articles which can be retrieved. When the query is received, the search engine compares the search terms with the keywords within articles in the database and determines whether the entered search terms match (or are found within) any of the documents within the database. When a match is found, a list of the documents that matches the search terms is returned/output to the user.

With the emergence of the web and large intranets, search engines have migrated online. These search engines are referred to as network search engines. Because different network search engines use different indexing and ranking techniques, users of search engines often desire to use multiple search engines so to effectuate an exhaustive search of a network. This usually entails opening a first web browser to utilize a first search engine, effectuating a search on the first search engine and then navigating the results of the first search engine. Next, the user opens a second web browser to utilize a second search engine, effectuating a search on the second search engine and then navigating the results of the second search engine. The user then re-executes the same sequence of steps for each additional search engine until all desired search engines have been evaluated.

The lengthy series of steps described above comes with drawbacks. This process can be time-consuming and tedious for the user. Furthermore, the process of opening separate web browsers initiating separate searches can be distracting to the user and cause a large processing burden upon the user's computer. The result of the steps described above is that the user is left with multiple open web browsers, wherein each web browser may be left at a different stage in the browsing process. Multiple open web browsers on one user desktop can be confusing to the user. Further, the user may not remember which search engine corresponds to each web browser and at what stage of browsing each web browser was left.

Another problem encountered by users of web browsers involves the sending of links. Often times, users desire to send other users a list of links to a set of web sites or network locations. For example, a teacher may desire to send a student a list of ten web sites that are useful for learning about a certain subject. In this example, the teacher amasses Universal Resource Locators (URLs) for each web site and writes them into an email or authors them onto a web page. Then, the student receives the email including the ten URLs or opens up the pertinent web page that includes the ten URLs. Subsequently, the student clicks on the first URL, which opens a first web browser that navigates to the site of the first URL, and the student proceeds to web surf on the site of the first URL. Next, the student clicks on the second URL, which opens a second web browser that navigates to the site of the second URL, and the student proceeds to web surf on the site of the second URL. The student then re-executes the same sequence of steps for each additional URL until all ten URLs have been visited.

Like the previous problem regarding search engines, the lengthy series of steps described above comes with drawbacks. This process can be time-consuming and tedious for the user, in addition to distracting to the user and detrimental to the user's computer due to the large processing burden. Again, the user is left with multiple open web browsers, wherein each web browser may be left at a different stage in the browsing process. This can confuse the user, the user may not remember which URL corresponds to each web browser and at what stage of browsing each web browser was left.

Therefore, there is a need to overcome the deficiencies with the prior art and more particularly for a more efficient way to conduct searches on multiple network search engines and a more efficient way to navigate network sites.

### BRIEF SUMMARY OF THE INVENTION

Embodiments of the present invention address deficiencies of the art in respect to web site navigation and provide a novel and non-obvious method, system and computer program product for navigating multiple web sites. In an embodiment of the invention, a method for facilitating the simultaneous initiation of a plurality of web sites can be provided. The method can include receiving from a client a request for a web page and sending to the client a first program logic configured for providing an interface. The method can further include receiving a plurality of URLs from the first program logic executing on the client. The method can further include generating a data construct, wherein the data construct includes a second program logic configured for sending a separate request to each of the plurality of URLs and further configured for receiving web site data from each of the plurality of URLs and displaying the web site data in the interface. The method can further include generating a first URL that references the data construct and sending the first URL to the client.

In another embodiment of the invention, a system for facilitating the simultaneous initiation of a plurality of web sites can be provided. The system can include a receiver for receiving from a client interface a plurality of URLs. The system can further include a processor configured for generating a data construct, wherein the data construct includes a second program logic configured for sending a separate request to each of the plurality of URLs and further configured for receiving web site data from each of the plurality of URLs and displaying the web site data in the interface, and further configured for generating a first URL that references the data construct. The system can further include a transmitter for sending the first URL to the client.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for providing simultaneous searching using multiple search engines and for providing transmission of an activation of multiple web sites, in accordance with one embodiment of the present invention;

FIG. 2 is an illustration of a web browser providing a system for providing simultaneous searching using multiple search engines and for providing transmission of an activation of multiple web sites, in accordance with one embodiment of the present invention;

FIG. 3 is a block diagram showing the data flow of a process for providing simultaneous searching using multiple search engines, in accordance with one embodiment of the present invention;

FIG. 4 is an illustration of a web browser providing a system for providing transmission of an activation of multiple web sites, in accordance with one embodiment of the present invention;

FIG. 5 is a block diagram showing the data flow of a process for providing transmission of an activation of multiple web sites, in accordance with one embodiment of the present invention;

FIG. 6 is a block diagram illustrating a computer system useful for implementing one embodiment of the present invention.

### DETAILED DESCRIPTION OF THE INVENTION

Embodiments of the present invention address deficiencies of the art in respect to web site navigation and provide a novel and non-obvious method, system and computer program product for navigating multiple web sites. In an embodiment of the invention, a method for facilitating the simultaneous initiation of a plurality of web sites can be provided. The method can include receiving from a client a request for a web page and sending to the client a first program logic configured for providing an interface. The method can further include receiving a plurality of URLs from the first program logic executing on the client. The method can further include generating a data construct, wherein the data construct includes a second program logic configured for sending a separate request to each of the plurality of URLs and further configured for receiving web site data from each of the plurality of URLs and displaying the web site data in the interface. The method can further include generating a first URL that references the data construct and sending the first URL to the client.

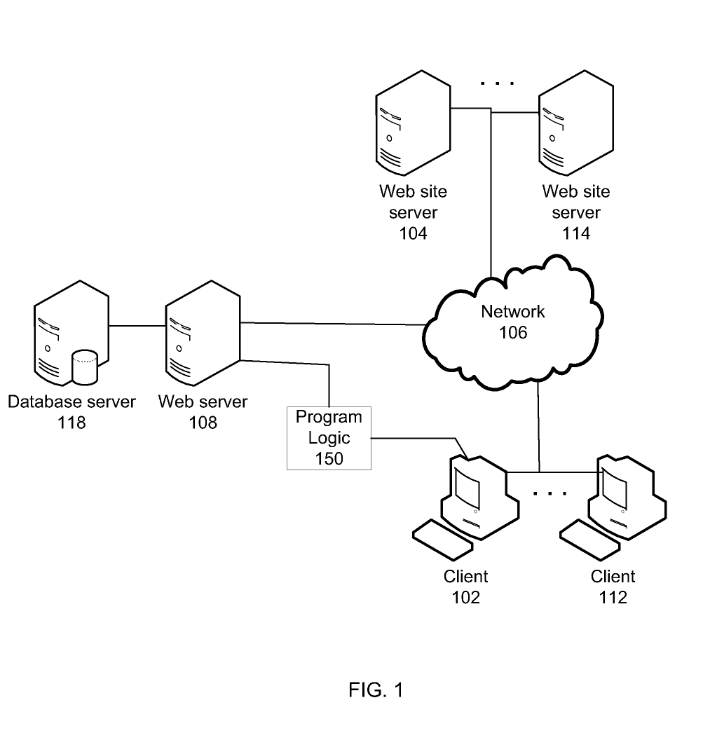

Referring now to the drawing figures in which like reference designators refer to like elements, there is shown in FIG. 1 an illustration of a block diagram showing the network architecture of a network application in accordance with the principles of the present invention. The exemplary embodiments of the present invention adhere to the system architecture of FIG. 1. FIG. 1 shows an embodiment of the present invention wherein client users 102-112 interact with web servers 104-114 and web server 108 over a network 106, such as in an Internet implementation of a network application that services multiple users in more than one location and for multiple tasks.

FIG. 1 shows client users 102-112, web servers 104-114 and web server 108 connected to network 106 via computers, such as desktop personal computers, workstations or servers. Web server 108 includes a software engine that delivers applications to client computers 102-112. The web server 108 may adhere to any commercially available server platform, such as the Sun Microsystems J2EE platform, a Web-based application platform, an integrated platform for e-commerce or a content management system platform. It should be noted that although FIG. 1 shows only two client users 102-112, two web site servers 104-114 and one web server 108, the system of the present invention supports any number of client users, web site server and servers connected via network 106. The web server 108 and its functions are described in more detail with reference to the figures below.

In one embodiment of the present invention, the network application provided by the web server 108 of FIG. 1 is a client-server application having a client portion that resides on the computers of client users 102-112 and a server application that resides on web server 108. For example, the network application can be a web interface that is accessed by client users 102-112 via network 106.

FIG. 1 further shows that web server 108 includes a database server 118. Client users 102-112 may also each include their own database. The database server 118 serves data from a database, which is a repository for data used by web server 108 and client users 102-112 during the course of operation. The data served by database server 118 is described in greater detail below. The database of database server 118 may adhere to any one of the flat model, hierarchical model, object-oriented model or a relational model for databases. Further, the database can be any commercially database, such as an Oracle Database, Enterprise or Personal Edition, available from Oracle Corporation, or a Microsoft SQL Server or Access 2000 database available from Microsoft Corporation.

The database server 118 may also include a database management system, which is an application that controls the organization, storage and retrieval of data (fields, records and files) in the database. A database management system accepts requests for data from the web server 108, and instructs the operating system to transfer the appropriate data. The database management system may also control the security and integrity of the database. Data security prevents unauthorized users from viewing or updating certain portions of the database. The database management system can be any commercially database management system, such as the Oracle E-Business Suite available from Oracle Corporation.

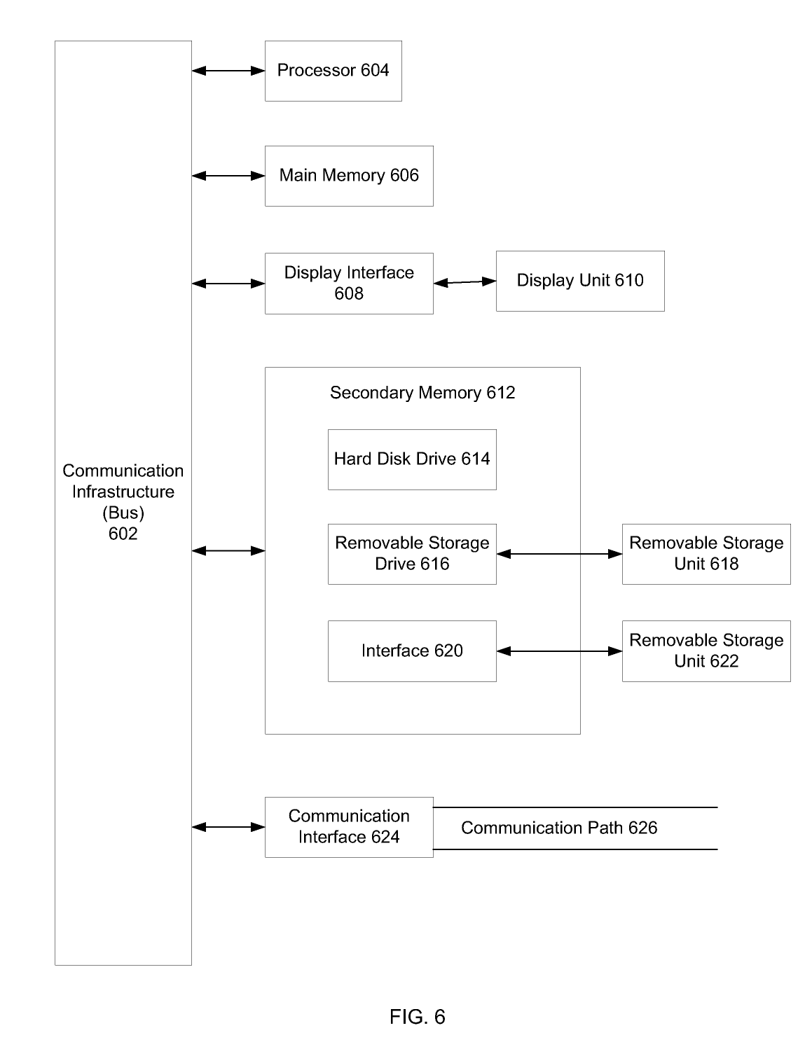

In an embodiment of the present invention, the computer systems of client users 102-112 and web server 108 are one or more Personal Computers (PCs), Personal Digital Assistants (PDAs), hand held computers, palm top computers, lap top computers, smart phones, game consoles or any other information processing devices. A PC can be one or more IBM or compatible PC workstations running a Microsoft Windows or LINUX operating system, one or more Macintosh computers running a Mac OS operating system, or an equivalent. In another embodiment, the computer systems of client users 102-112 and web server 108 are a server system, such as SUN Ultra workstations running a SunOS operating system or IBM RS/6000 workstations and servers running the AIX operating system. The computer systems of client users 102-112 and web server 108 are described in greater detail below with reference to FIG. 6.

In an embodiment of the present invention, the network 106 is a circuit switched network, such as the Public Service Telephone Network (PSTN). In another embodiment, the network 106 is a packet switched network. The packet switched network is a wide area network (WAN), such as the global Internet, a private WAN, a local area network (LAN), a telecommunications network or any combination of the above-mentioned networks. In yet another embodiment, the structure of the network 106 is a wired network, a wireless network, a broadcast network or a point-to-point network.

Web server 108 connects directly to the network 106 via a network interface, such as a network interface card. The web server 108 provides a web interface available to client users 102-112. This is advantageous as a web interface allows any clients having a web connection to connect to the web server 108. A web interface provides a simple, efficient, highly compatible, economical and highly available connection to the web server 108 to a wide range of clients.

FIG. 1 shows a group of client users 102-112 connecting to the web server 108. These clients may execute client applications, such as compiled or interpreted executable modules written in C++, Java, Visual Basic, HTML, XML, Flash or separate Java applets, Java scriptlets, Java scripts, Perl scripts, Active X controls or any self-sufficient application executing on a client computer.

FIG. 1 further shows program logic 150 comprising computer source code, scripting language code or interpreted language code that is compiled to produce computer instructions that perform various functions of the present invention. In one embodiment of the present invention, the program logic 150 is a scripting language such as ECMAScript, Cascading style sheets, XML, XSLT, Javascript, AJAX, XUL, JSP, PHP, and ASP. Program logic 150 may reside on a client 102, the web server 108 or any combination of the two.

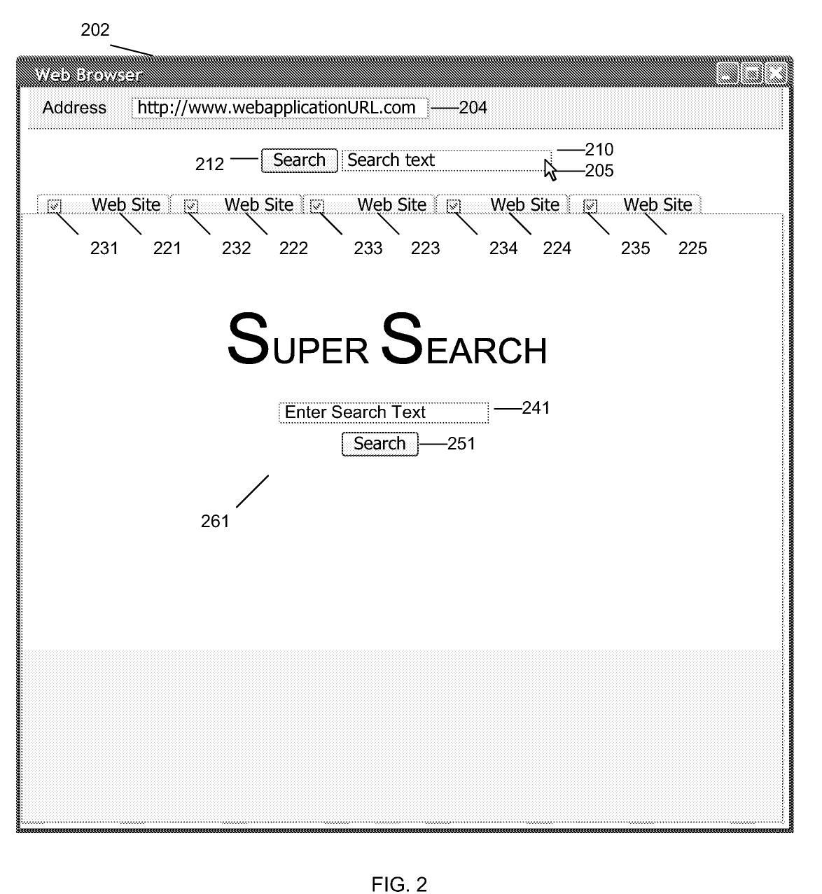

FIG. 2 is an illustration of a web browser 202 providing a system for providing simultaneous searching using multiple search engines and for providing transmission of an activation of multiple web sites, in accordance with one embodiment of the present invention. FIG. 2 shows that the web browser 202 includes an address text field 204 that indicates a Universal Resource Locator (URL) of a web site. Upon entering the appropriate URL, the web browser 202 sends a HyperText Transfer Protocol (HTTP) request for data to the appropriate web server, such as web server 108, corresponding to said URL. Subsequently, the web server 108 sends the appropriate web page data to the web browser 202. The web page data received by the web browser 202 may be HTML or may comprise some or all of the program logic 150, which may be a scripting language such as XML, XSLT, Javascript, etc. Upon receiving the web page data sent by web server 108, web browser 202 executes the web page data and thereby displays it as the interface shown in FIG. 2.

Web browser 202 includes a text field 210 for the provision of search parameters and a button 212 for initiating a search based on the search parameters entered into text field 210. The user may place his mouse cursor 205 into the text field 210 to enter the desired search parameters and may use the mouse cursor 205 to press the button 212.

FIG. 2 further shows that several tabs 221, 222, 223, 224 and 225 are shown wherein the first tab 221 is currently activated. That is, the page 261 corresponding to tab 221 is displayed while the pages that correspond to tabs 221, 222, 223, 224 and 225 are not displayed as they are behind the active page 261. Each tab 221, 222, 223, 224 and 225 corresponds to a different search engine available over a network such as the internet or the web. Page 261provides a web page for the search engine corresponding to the search engine of tab 231. Page 261 provides a conventional text field 241 for the provision of search parameters and a button 251 for initiating a search based on the search parameters entered into text field 241.

Each tab has a checkbox associated with it. Tab 221 includes checkbox 231, tab 222 includes checkbox 232, tab 223 includes checkbox 233, tab 224 includes checkbox 234, and tab 225 includes checkbox 235. The user of web browser 202 may place a check in those checkboxes corresponding to the search engines where the user desires to initiate a search for the search parameters entered into text field 210.

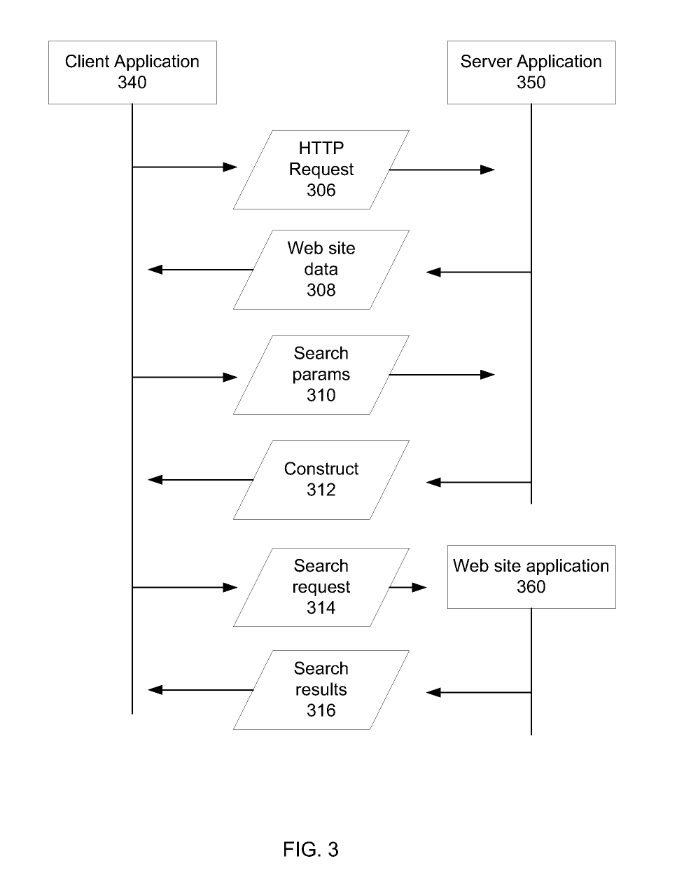

FIG. 3 is a block diagram showing the data flow of a process for providing simultaneous searching using multiple search engines, in accordance with one embodiment of the present invention. FIG. 3 shows a client application 340 corresponding to all or a portion of program logic 150 residing on a client computer such as client 102. The client application 340 may be a web browser, such as web browser 202, executing program logic 150. FIG. 3 further shows a server application 350 corresponding to all or a portion of program logic 150 residing on a server such as web server 108. FIG. 3 further shows a web server application 360 residing on a web server such as web server 104.

FIG. 3 shows that the client application 340 sends a request 306, such as an HTTP request, for data to the server application 350. The server application 350 sends the appropriate web page data 308, comprising HTML or a scripting code language file or data packet, to the client application 340. The web page data 308 received by the client application 340 is executed by the client application 340 and thereby displayed in an interface, such as shown in web browser 202.

Upon entering of search parameters 310 by the user into the interface provided by web page data 308, the search parameters 310 are sent by the client application 340 to the server application 350. In one alternative, upon entering of search engine selections by the user into the interface provided by web page data 308, the search engine selections are sent by the client application 340 to the server application 350. Search engines may be selected, for example, by checking off checkboxes 231, 232, 233, 234, 235. The server application 350 subsequently receives the search parameters 310 (and/or the search engine selections) and generates a data construct 312 based on the received data.

The data construct 312 generated by the server application 350 may be HTML or may comprise some or all of the program logic 150, which may be a scripting language such as XML, XSLT, Javascript, etc. The data construct 312 includes computer instructions that, when executed by client application 340, send out a separate request, such as an HTTP request 314, to each search engine (i.e., web server application 360) selected by the user, wherein each request initiates a search on the respective search engine for the search parameters 310.

For example, if the user selected the search engines corresponding to tabs 221 and 222 using checkboxes 231, 232, respectively, and the user entered the search parameters “Abraham Lincoln” into the text field 210, then the data construct 312 would include computer instructions that: 1) send out one HTTP request to the search engine corresponding to tab 221, wherein the HTTP request initiates a search for the search parameter “Abraham Lincoln,” and 2) 1) send out one HTTP request to the search engine corresponding to tab 222, wherein the HTTP request initiates a search for the search parameter “Abraham Lincoln.”

In response to receiving the search requests 314, the web server application 360 for each web server 104-114 executes a search based on the search parameters in request 314. The web server application 360 for each web server 104-114 generates a list of search results as a result of the executed search. Each web server application 360 for each web server 104-114 subsequently sends its search results (search results data 316), comprising HTML, a scripting code language file or data packet, to the client application 340. The search results data 316 received by the client application 340 is executed by the client application 340 and thereby displayed in the interface, such as web browser 202. Thus, the data flow of FIG. 3 describes how the web browser 202 is populated with the search results data 316 in response to a single press of the button 212.

As described above, the web browser 202 is populated with the search results data 316. Using the above example, wherein the user selected the search engines corresponding to tabs 221 and 222 and the user entered the search parameters “Abraham Lincoln” into the text field 210, tab 221 is populated with the search results of the first selected search engine and tab 222 is populated with the search results of the second selected search engine. Thus, the user of web browser 202 is able to simultaneously initiate a search on multiple search engines and, in response to one button press (button 212), receive and display the search results from the multiple search engines. Note that all selected tabs (i.e., selected search engines) receive search results at the same or substantially the same time. Although FIG. 2 shows that only one tab or page is displayed at one time, upon clicking of underlying tabs using the mouse cursor 205, the underlying tab (and its already present search results) is displayed.

It should further be noted that although all selected tabs (i.e., selected search engines) receive search results at the same or substantially the same time, some tabs may be populated quicker than others due to a slow web site server. FIG. 2 shows that only one tab or page is displayed at one time, and therefore while one or more tabs are in the process of being populated or loaded due to a slow web site server, upon clicking of already-populated underlying tabs using the mouse cursor 205, the underlying tab (and its already loaded search results) can be displayed.

The simultaneous, or near simultaneous, population or loading of all of the tabs 221, 222, 223, 224 and 225 allows for quick and easy access to the page or pages displayed by each tab. As explained above, upon clicking of a tab using the mouse cursor 205, the tab (and its already loaded search results) can be displayed. Tabs are not populated or loaded upon clicking of the tab but rather are loaded simultaneously or near-simultaneously when search results data 316 is received by the web browser 202. Therefore, after loading of the search results data 316, a user can expeditiously access any page displayed by a tab without having to wait for it to load.

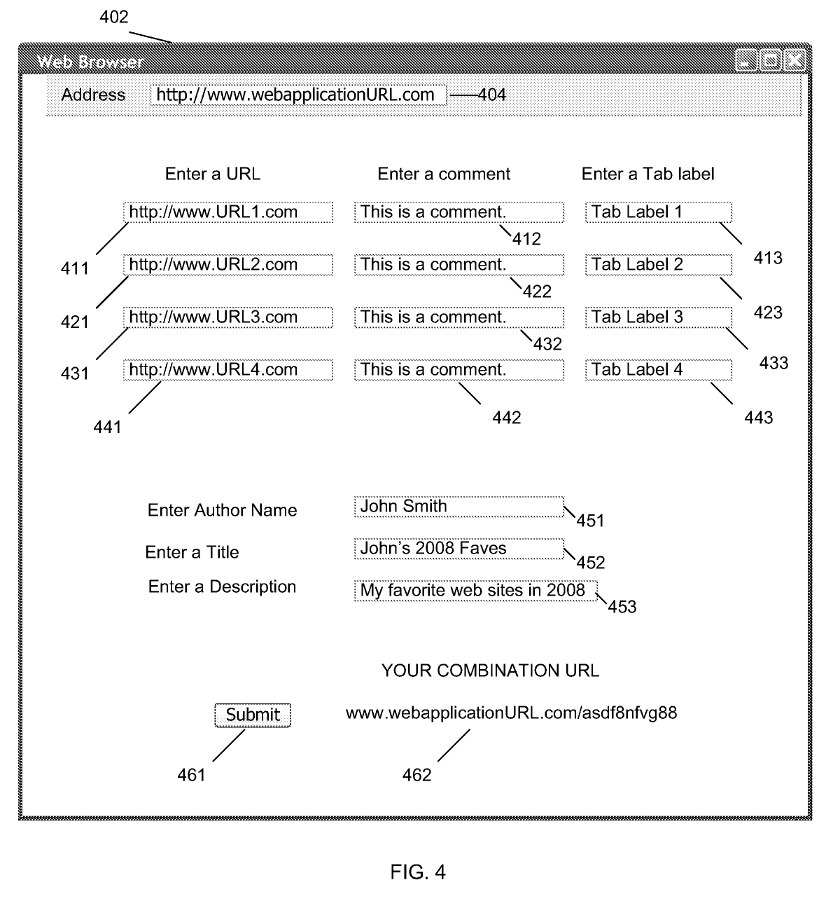

FIG. 4 is an illustration of a web browser 402 providing a system for providing transmission of an activation of multiple web sites, in accordance with one embodiment of the present invention. An activation of multiple web sites is a data construct or a set of program logic that, when executed, simultaneously initiates the automatic display of multiple enumerated web sites.

FIG. 4 shows that the web browser 402 includes an address text field 404 that indicates URL of a web site. Upon entering the appropriate URL, the web browser 402 sends an HTTP request for data to the appropriate web server, such as web server 108, corresponding to said URL. Subsequently, the web server 108 sends the appropriate web page data to the web browser 402. The web page data received by the web browser 402 may be HTML or may comprise some or all of the program logic 150, which may be a scripting language such as XML, XSLT, Javascript, etc. Upon receiving the web page data sent by web server 108, web browser 402 executes the web page data and thereby displays it as the interface shown in FIG. 4.

Web browser 202 includes various text fields 411, 421, 431 and 441 for the provision of URLs. For each URL text field 411, 421, 431 and 441, there is a corresponding comment text field, 412, 422, 432, 442, respectively, for the provision of a comments describing the URL. Also, for each URL text field 411, 421, 431 and 441, there is a corresponding tab label text field, 413, 423, 433, 443, respectively, for the provision of a tab labels describing the URL.

FIG. 4 further provides an author text field 451 for the provision of the name of the author of the activation of multiple web sites. A title text field 452 allows a user to enter a title for the activation and a description text field 453 allows a user to enter a description of the activation. A submit button 461 allows a user to submit the data entered into web browser 402 to the server 108, which replies with a URL 462 that is displayed in the web browser 402. The URL 462 provides a link or an address to a data construct or a set of program logic that, when executed, simultaneously initiates the automatic display of the web sites defined by the URLs entered by the user in URL text field 411, 421, 431 and 441.

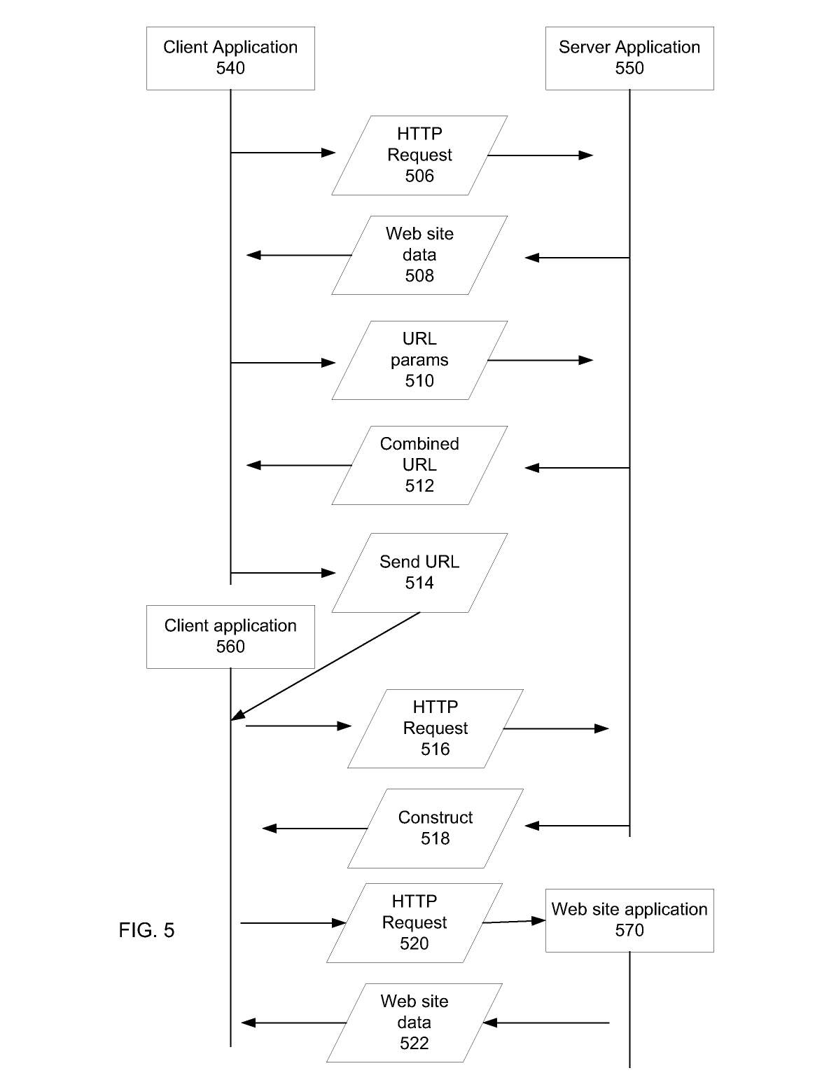

FIG. 5 is a block diagram showing the data flow of a process for providing transmission of an activation of multiple web sites, in accordance with one embodiment of the present invention. FIG. 5 shows a client application 540 corresponding to all or a portion of program logic 150 residing on a client computer such as client 102. The client application 540 may be a web browser, such as web browser 402, executing program logic 150. FIG. 5 further shows a server application 550 corresponding to all or a portion of program logic 150 residing on a server such as web server 108. FIG. 5 further shows another client application 560 corresponding to all or a portion of program logic 150 residing on another client computer such as client 112. FIG. 5 further shows a web server application 570 residing on a web server such as web server 104.

FIG. 5 shows that the client application 540 sends a request 506, such as an HTTP request, for data to the server application 550. The server application 550 sends the appropriate web page data 508, comprising HTML or a scripting code language file or data packet, to the client application 540. The web page data 508 received by the client application 540 is executed by the client application 540 and thereby displayed in an interface, such as shown in web browser 402.

Upon entering of parameters by the user into the interface provided by web page data 508, the parameters 510 are sent by the client application 540 to the server application 550. The parameters 510 include all such data entered by the user into the web browser 402. The server application 550 subsequently receives the parameters 510 and generates a data construct 518 based on the received data.

The data construct 518 generated by the server application 550 may be HTML or may comprise some or all of the program logic 150, which may be a scripting language such as XML, XSLT, Javascript, etc. The data construct 518 includes computer instructions that, when executed by a client application 540 or 560, send out a separate request, such as an HTTP request, to each URL entered by the user in web browser 404, wherein each request initiates a display of the defined web site in an interface, such as web browser 204.

The server application 550 subsequently generates a URL 512 that corresponds to the data construct 518 generated by the server application 550. The URL 512 defines an address or link that directs a user to the location of the data construct 518. Next, the user of the client application 540 sends the URL 512 (in a data packet 514 such as an email) to another user utilizing client application 560. The client application 560 uses an interface such as a web browser 204 to follow the URL 512 to its defined location. Thus, the client application 560 sends to server application 550 a request, such as an HTTP request 516, for the data construct 518 defined by the URL 512. The server application 550 responds by sending the data construct 518 to the client application 560. Subsequently, the client application 560 executes the data construct 518.

As explained above, the data construct 518 includes computer instructions that, when executed by client application 560, send out a separate request, such as an HTTP request, to each URL entered by the user in web browser 404, wherein each request initiates a display of the defined web site in an interface, such as web browser 204. Thus, the client application 560 sends out one or more requests, such as HTTP requests 520, to the web server applications 570 of the web sites defined in the data construct 518. In response to the HTTP requests 520, the web server application 570 for each web server 104-114 sends the appropriate web page data 522, comprising HTML, a scripting code language file or data packet, to the client application 560. The web page data 522 received by the client application 560 is executed by the client application 560 and thereby displayed in the interface, such as web browser 202.

In an embodiment of the present invention, upon display of the web page data 522 by the client application 560, the client application 560 further displays additional information entered by the user in web browser 404. For example, the interface displayed by client application 560 may display for each URL in each tab the comments entered by the user in comment text fields, 412, 422, 432, 442, respectively. The interface displayed by client application 560 may further display for each tab the tab label entered by the user in tab label text field, 413, 423, 433, 443, respectively, for the provision of a tab labels describing the URL. The interface displayed by client application 560 may further display an author of the activation entered by the user in author text field 451, a title of the activation as entered by the user in title text field 452 and a description of the activation as entered by the user in the description text field 453.

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allows a computer system to read such computer readable information.

FIG. 6 is a block diagram of a computer system useful for implementing an embodiment of the present invention. The computer system of FIG. 6 is a more detailed representation of client computers 102-112 and web server 108. The computer system of FIG. 6 includes one or more processors, such as processor 604. The processor 604 is connected to a communication infrastructure 602 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 608 that forwards graphics, text, and other data from the communication infrastructure 602 (or from a frame buffer not shown) for display on the display unit 610. The computer system also includes a main memory 606, preferably random access memory (RAM), and may also include a secondary memory 612. The secondary memory 612 may include, for example, a hard disk drive 614 and/or a removable storage drive 616, representing a floppy disk drive, a magnetic tape drive, an optical disk drive, etc. The removable storage drive 616 reads from and/or writes to a removable storage unit 618 in a manner well known to those having ordinary skill in the art. Removable storage unit 618, represents, for example, a floppy disk, magnetic tape, optical disk, etc. which is read by and written to by removable storage drive 616. As will be appreciated, the removable storage unit 618 includes a computer usable storage medium having stored therein computer software and/or data.

In alternative embodiments, the secondary memory 612 may include other similar means for allowing computer programs or other instructions to be loaded into the computer system. Such means may include, for example, a removable storage unit 622 and an interface 620. Examples of such may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to the computer system.

The computer system may also include a communications interface 624. Communications interface 624 allows software and data to be transferred between the computer system and external devices. Examples of communications interface 624 may include a modem, a network interface (such as an Ethernet card), a communications port, a PCMCIA slot and card, etc. Software and data transferred via communications interface 624 are in the form of signals which may be, for example, electronic, electromagnetic, optical, or other signals capable of being received by communications interface 624. These signals are provided to communications interface 624 via a communications path (i.e., channel) 626. This channel 626 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 606 and secondary memory 612, removable storage drive 616, a hard disk installed in hard disk drive 614, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allows a computer to read such computer readable information.

Computer programs (also called computer control logic) are stored in main memory 606 and/or secondary memory 612. Computer programs may also be received via communications interface 624. Such computer programs, when executed, enable the computer system to perform the features of the present invention as discussed herein. In particular, the computer programs, when executed, enable the processor 604 to perform the features of the computer system. Accordingly, such computer programs represent controllers of the computer system.

Advantageously, the present invention provides a method, system and computer readable medium for managing various amounts of media elements by providing an assortment of functions to be performed on media elements, such as re-linking, merging, viewing dependencies and differentiating. Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for facilitating the simultaneous initiation of a plurality of web sites, comprising:
receiving from a client a request for a web page;
sending to the client a first program logic configured for providing an interface;
receiving a plurality of URLs from the first program logic executing on the client;
generating a data construct, wherein the data construct includes a second program logic configured for sending a separate request to each of the plurality of URLs and further configured for receiving web site data from each of the plurality of URLs and displaying the web site data in the interface;
generating a first URL that references the data construct; and
sending the first URL to the client.

2. The method of claim 1, wherein the step of receiving from a client a request for a web page comprises:
receiving from a web browser an HTTP request for a web page.

3. The method of claim 2, wherein the step of sending to the client a first program logic configured for providing an interface comprises:
sending to the web browser a first program logic configured for providing an interface including a web page, wherein the first program logic comprises scripting language code.

4. The method of claim 3, wherein the step of receiving a plurality of URLs from the first program logic executing on the client comprises:
receiving from the first program logic executing on the web browser a plurality of URLs, wherein each URL comprises a text string.

5. The method of claim 4, wherein the step of generating a data construct comprises:
generating a data construct comprising scripting language code, wherein the data construct includes a second program logic configured for sending a separate HTTP request to each of the plurality of URLs and further configured for receiving web site data from each of the plurality of URLs and displaying the web site data in the interface.

6. The method of claim 5, wherein the step of sending the first URL to the client comprises:
sending the first URL to the client via an HTTP message.

7. A computer program product comprising a computer usable medium embodying computer usable program code for facilitating the simultaneous initiation of a plurality of web sites, the computer program product comprising:
computer usable program code for receiving from a client a request for a web page;
computer usable program code for sending to the client a first program logic configured for providing an interface;
computer usable program code for receiving a plurality of URLs from the first program logic executing on the client;
computer usable program code for generating a data construct, wherein the data construct includes a second program logic configured for sending a separate request to each of the plurality of URLs and further configured for receiving web site data from each of the plurality of URLs and displaying the web site data in the interface;
computer usable program code for generating a first URL that references the data construct; and
computer usable program code for sending the first URL to the client.

8. The computer program product of claim 7, wherein the computer usable program code for receiving from a client a request for a web page comprises:
computer usable program code for receiving from a web browser an HTTP request for a web page.

9. The computer program product of claim 8, wherein the computer usable program code for sending to the client a first program logic configured for providing an interface comprises:
computer usable program code for sending to the web browser a first program logic configured for providing an interface including a web page, wherein the first program logic comprises scripting language code.

10. The computer program product of claim 9, wherein the computer usable program code for receiving a plurality of URLs from the first program logic executing on the client comprises:
computer usable program code for receiving from the first program logic executing on the web browser a plurality of URLs, wherein each URL comprises a text string.

11. The computer program product of claim 10, wherein the computer usable program code for generating a data construct comprises:
computer usable program code for generating a data construct comprising scripting language code, wherein the data construct includes a second program logic configured for sending a separate HTTP request to each of the plurality of URLs and further configured for receiving web site data from each of the plurality of URLs and displaying the web site data in the interface.

12. The computer program product of claim 11, wherein the computer usable program code for sending the URL to the client comprises:
computer usable program code for sending the first URL to the client via an HTTP message.

13. A server for facilitating the simultaneous initiation of a plurality of web sites, comprising:
a receiver for receiving from a client interface a plurality of URLs;
a processor configured for generating a data construct, wherein the data construct includes a second program logic configured for sending a separate request to each of the plurality of URLs and further configured for receiving web site data from each of the plurality of URLs and displaying the web site data in the interface, and further configured for generating a first URL that references the data construct; and
a transmitter for sending the first URL to the client.

14. The server of claim 13, wherein the client interface is a web browser.

15. The server of claim 14, wherein the plurality of URLs are received in an HTTP message.

16. The server of claim 15, wherein the first program logic comprises scripting language code.

17. The server of claim 16, wherein a URL comprises a text string.

18. The server of claim 17, wherein the data construct comprises scripting language code.

19. The server of claim 18, wherein the first URL is sent to the client via an HTTP message.
